(19) United States
(12) Patent Application Publication
(10) Pub. No.: US 2004/0003902 A1
(43) Pub. Date: Jan. 8, 2004

(54) Headbox assembly for vertical blind

(76) Inventor: Hsi-Hui Nien, Changhua (TW)

Correspondence Address: BACON & THOMAS, PLLC, 625 SLATERS LANE, FOURTH FLOOR, ALEXANDRIA, VA, 22314

(21) Appl. No.: 10/189,593

(22) Filed: Jul. 8, 2002

(51) Int. Cl. E06B 9/36

(52) U.S. Cl. 160/168.1 V

(57) ABSTRACT

A headbox assembly for vertical blind is constructed to include a headbox having a track inside, a plurality of carriers slidably mounted in the track inside the headbox, an end bracket adapted for fastening to the headbox to close one end of the headbox, and a locating plate. The end bracket has a clamp inserted into one end of the headbox and adapted for holding a first one of the carriers. The locating plate is adapted for fastening to the headbox to fixedly secure the end bracket to one end of the headbox.

### BACKGROUND OF THE INVENTION

1. Field of the Invention

The present invention relates to vertical blinds and, more specifically, to a headbox assembly for vertical blind.

2. Description of the Related Art

Conventional blinds are made in a series of sizes to fit windows of particular specifications. These blinds are called sized blinds that can easily be purchased from the market. However, there are buildings with specifically designed windows. Regular commercially available blinds may not fit these specifically designed windows. In this case, custom-built blinds shall be used. However, custom-built blinds are commonly expensive. In order to save cost, sized blinds may be selected and cut according to the sized of the specifically designed windows.

However, during the fabrication of a sized blind, the last carrier (the carrier at one lateral side) is fixed to the headboard in position. Fixing the last carrier to the headbox in position is to prevent displacement of the slats during the use of the blind. When the consumer cut the headbox to fit a particular window, the positioning structure of the last carrier may be destroyed, resulting in unstable positioning of the carriers. Further, the headbox of a blind has a through hole in each end for the mounting of an endpiece. When the headbox of a sized blind cut by the consumer according to the desired size, the consumer shall have to drill a through hole in the cut end of the headbox for the mounting of the respective endpiece. Making such a through hole requires a special tool, for example, a drill.

### SUMMARY OF THE INVENTION

The present invention has been accomplished to provide a headbox assembly for vertical blind, which eliminates the aforesaid problems. It is therefore the main object of the present invention to provide a headbox assembly for vertical blind, which enables the headbox to be cut according to the desired length and the side carrier to be secured in position in one end of the well-cut headbox.

To achieve this object of the present invention, the headbox assembly for vertical blind is comprised of a headbox having a track inside, a plurality of carriers mounted in the track inside the headbox, an end bracket adapted for fastening to the headbox to close one end of the headbox, and a locating plate. The end bracket has a clamp inserted into one end of the headbox and adapted for holding a first one of the carriers. The locating plate is adapted for fastening to the headbox to fixedly secure the end bracket to one end of the headbox.

### BRIEF DESCRIPTION OF THE DRAWINGS

FIG. 1 is an exploded view of a headbox assembly for vertical blind according to the first embodiment of the present invention.

FIG. 2 is a schematic drawing of the first embodiment of the present invention, showing the carriers and the slats extended out.

FIG. 3 is a schematic drawing of the second embodiment of the present invention, showing the carriers and the slats extended out.

FIG. 4 is another schematic drawing of the second embodiment of the present invention, showing the carriers and the slats received.

### DETAILED DESCRIPTION OF THE PREFERRED EMBODIMENT

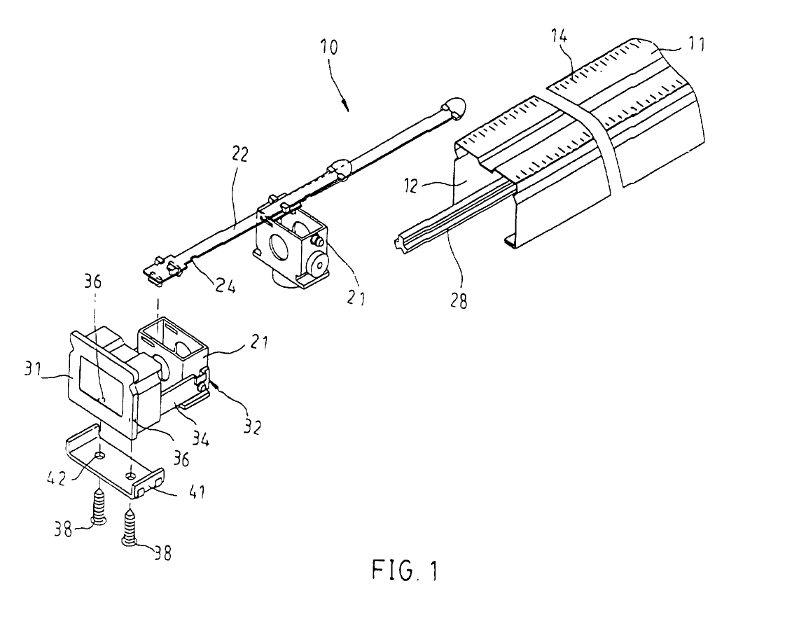

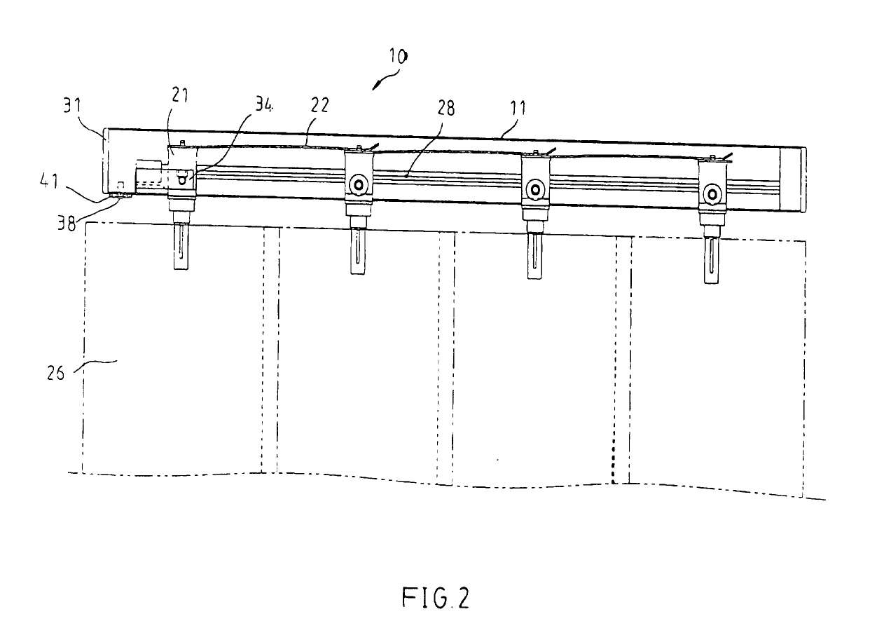

Referring to FIGS. 1 and 2, a headbox assembly 10 for vertical blind in accordance with the first embodiment of the present invention is shown comprised of a headbox 11, a plurality of carriers 21, and at least one end detachable bracket 31 and one locating plate 41.

The headbox 11 is an elongated rectangular extruded casing having the two distal ends and bottom side thereof opened. A scale 14 is marked on the top surface of the headbox 11 so that the consumer can conveniently cut the headbox 11 subject to the desired length.

The carriers 21 are mounted in proper order in a track 12 defined in the headbox 11, each having a top side coupled to a respective sliding rod 22. The sliding rod 22 has a notch 24 near one end. The notch 24 enables the sliding rod 22 to be easily detached from the corresponding carrier 21. Each carrier 21 carries a respective vertical slat 26. A rail 28 is inserted through the carriers 21. By means of the action of the driving gear in each carrier 21, the slats 26 are synchronously rotated. The structure of the driving gears of the carriers 21 and the related driving gear linking mechanism are of the known art and not within the scope of the claims of the present invention, no further detailed description in this regard is necessary.

The detachable end bracket 31 is mountable to one end of the headbox 11, comprising a clamp 32 adapted for holding the last carrier 21 and two mounting holes 36 bilaterally disposed in the bottom wall thereof. The clamp 32 is comprised of two parallel clamping arms 34 extended in direction corresponding to the longitudinal axis of the track 12.

The locating plate 41 is a thin sheet member fitting over the bottom open side of the headbox 11, having two through holes 42 corresponding to the mounting holes 26 of the detachable end bracket 31.

When the consumer cut the headbox 11 according to the desired length, the end bracket 31 is plugged into one end of the well-cut headbox 11, and then the locating plate 41 is attached to the bottom open side of the headbox 11, keeping the through holes 42 in alignment with the mounting holes 36, and then screws 38 are respectively mounted in the through holes 42 and threaded into the mounting holes 36 to fix the locating plate 41 and the end bracket 31 to the well-cut headbox 1. When installed, the clamping arms 34 of the clamp 32 of the end bracket 31 hold down the last carrier 21, preventing the last carrier 21 from sliding along the rail 28.

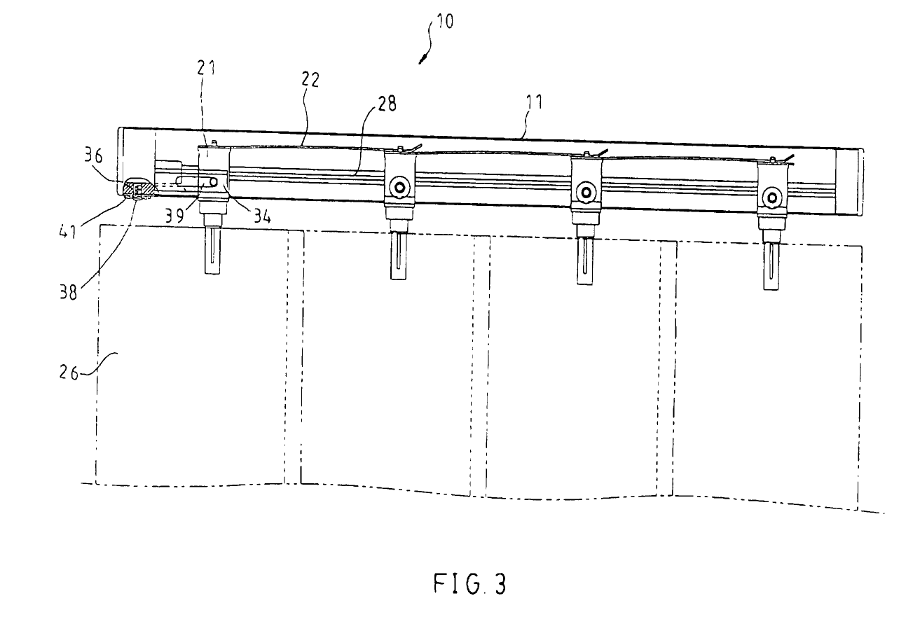

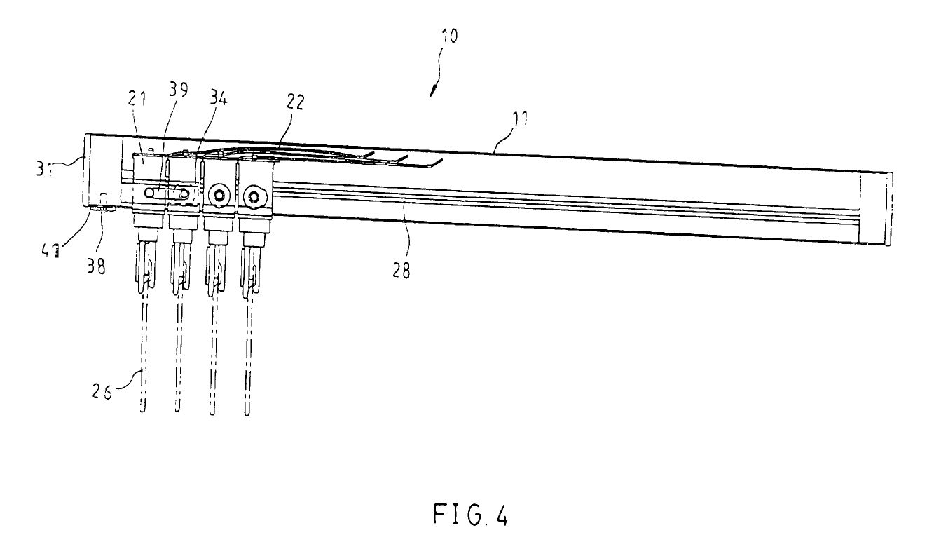

FIGS. 3 and 4 show a headbox assembly 10 according to the second embodiment of the present invention. According to this embodiment, the clamping arms 34 of the end bracket 31 each have a longitudinal sliding slot 39. The last carrier 21 is coupled to the longitudinal sliding slots 39 of the clamping arms 34, and can be moved along the rail 28 within the limit of the longitudinal sliding slots 39. When the carriers 21 and the slats 26 extended out, the last carrier 21 is stopped at the front ends of the longitudinal sliding slots 39 of the clamping arms 34 (see FIG. 3). When the carriers 21 and the slats 26 received, the last carrier 21 is stopped at the rear ends of the longitudinal sliding slots 39 of the clamping arms 34 (see FIG. 4).

What the invention claimed is:

1. A headbox assembly for vertical blind comprising:
a headbox having a track inside;
a plurality of carriers slidably mounted in said track inside said headbox;
an end bracket adapted for fastening to said headbox to close one end of said headbox, said end bracket having a clamp inserted into one end of said headbox and adapted for holding a first one of said carriers; and
a locating plate adapted for fastening to said headbox to fixedly secure said end bracket to one end of said headbox.

2. The headbox assembly for vertical blind as claimed in claim 1, wherein said headbox has a scale marked on a top surface thereof.

3. The headbox assembly for vertical blind as claimed in claim 1, wherein said carriers each have a top side coupled with a sliding rod, said sliding rod having a notch near one end thereof.

4. The headbox assembly for vertical blind as claimed in claim 1, wherein said carriers each carry a respective vertical slat at a bottom side.

5. The headbox assembly for vertical blind as claimed in claim 1, wherein the clamp of said end bracket is comprised of two clamping arms.

6. The headbox assembly for vertical blind as claimed in claim 1, wherein said end bracket has two mounting holes disposed in a bottom wall thereof for the mounting of said locating plate.

7. The headbox assembly for vertical blind as claimed in claim 6, wherein said locating plate has two through holes adapted for fastening to the mounting holes of said end bracket by fastening means.

8. The headbox assembly for vertical blind as claimed in claim 5, wherein the clamping arms of said clamp of said end bracket each have a longitudinal sliding slot respectively coupled to two opposite sides of said first one of said carriers.
